(19) United States
(12) Patent Application Publication
(10) Pub. No.: US 2010/0039061 A1
(43) Pub. Date: Feb. 18, 2010

(54) SOLAR-POWERED WATER BUBBLER

(75) Inventor: Richard W. Rosenbaum, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(73) Assignee: REDEVEX CORPORATION, Birmingham, MI (US)

(21) Appl. No.: 12/190,823

(22) Filed: Aug. 13, 2008

(51) Int. Cl. H02J 7/32

(52) U.S. Cl. 320/101

(57) ABSTRACT

A self-contained solar-powered system and method prevent outdoor ice buildup. The apparatus includes a solar panel outputting electrical power, and a rechargeable battery in electrical communication with the solar panel for storing the power. An electrically operated air compressor is powered by the solar panel and/or battery, and a bubbler unit is in pneumatic communication with the air compressor, providing bubbler reaction to a water reservoir to be protected from freezing. An electronic controller is operative to activate electrical power switching apparatus on a per-demand basis. For example, at least one thermometer may be provided in electrical communication with the controller, with the controller being operative to activate the bubbler upon the detection that potential freezing may occur. The use of a controller and switching apparatus allows the battery to be charged at a higher capacity during times when freezing is unlikely.

### FIELD OF THE INVENTION

This invention relates generally to outdoor water freeze prevention and, in particular, to a solar-powered water bubbler to prevent freezing.

### BACKGROUND OF THE INVENTION

There are many instances where it would be desirable to keep outdoor liquid reservoirs from freezing. Examples include pet watering stations, livestock troughs, ponds and waterways.

There are examples wherein solar energy is used to prevent freezing, but passive solar is used. One example is disclosed in U.S. Pat. No. 4,108,156, entitled “Solar-heated stock tank.” The tank, with insulated walls and a drinking trough on a side, is surrounded by a larger stock tank to protect it from livestock. The heated stock tank has a steel plate above the water. Copper tubes depending from the plate are immersed in the water within the heated tank. A transparent covering is over the heated tank. A vertically oriented mirror is mounted on a heated tank wall directs additional sunlight through the transparent covering to the steel plate. The heat energy in the steel plate is conducted through the copper tubes into the water. In addition, the transparent covering produces a “hothouse” effect by trapping the heated air beneath the transparent covering.

There are also examples of solar-powered ‘bubblers’ in outdoor reservoirs, but they are used for oxygenation and not de-icing. U.S. Pat. No. 6,676,837 discloses such a system. The basic components are the solar panel, a control box, a length of air pipe, and a diffuser. The basic function of the system is to release gas into the bottom of the lake such that bubbles form and rise to the surface. The gas may be simply compressed air or may have a high oxygen or ozone content to promote oxygenation of the water.

The system incorporates a battery so that it does not require connection to the electrical power grid and may be used in any location. In wintertime, ice may cover a body of water and further compromise the oxygen levels, since no oxygen is being introduced to the body of water. Since the water is not aerated during the period that the ice covers the body of water, low oxygen levels can result in fish kill since the water body is effectively sealed from any further oxygenation. Bottom aeration in the winter months may prevent permanent ice formation.

Floating aeration apparatus are also known. For example, U.S. Pat. No. 3,794,303 resides in a method and apparatus for aerating bodies of open water utilize unbalanced water columns interconnected at their upper ends to provide continuous aeration of the water at any desired depth. The head on one column is attained by the introduction of air into the other column which serves both to raise and to aerate the water therein. Alternatively, the water may be circulated by mechanical means and the air introduced at the top of its travel. Undissolved air is permitted to escape as it passes between the columns before it enters the return column.

### SUMMARY OF THE INVENTION

This invention resides in a self-contained solar-powered system and method for preventing outdoor ice buildup. The invention is applicable to bodies of water of different sizes, including very small vessels such as pet and livestock watering bowls or troughs, to ponds, streams, and the like.

The apparatus includes a solar panel outputting electrical power, and a rechargeable battery in electrical communication with the solar panel for storing the power. An electrically operated air compressor is powered by the solar panel and/or battery, and a bubbler unit is in pneumatic communication with the air compressor, providing bubbler reaction to a water reservoir to be protected from freezing.

The apparatus may include switching apparatus to control the power supply to the battery and/or the power supply to the compressor from the battery. Preferably, an electronic controller is operative to activate the switching apparatus on a per-demand basis. For example, at least one thermometer may be provided in electrical communication with the controller, with the controller being operative to activate the bubbler upon the detection that potential freezing may occur. The use of a controller and switching apparatus allows the battery to be charged at a higher capacity during times when freezing is unlikely.

A plurality of thermometers may be provided for more accurate freeze prediction, including one in the water to be protected and, perhaps, one outside of the water to test for ambient air temperature. The controller may make comparisons between the various readings to derive an intelligent determination of potential freezing conditions, perhaps taking wind chill into account.

As discussed, the apparatus and method may be applied to volumes of water of different sizes, ranging from small pet bowls and livestock feeding troughs to ponds, streams, and so forth. In accordance with the latter applications, an alternative embodiment of the invention places the solar panel on a floating housing containing various electronics, with the bubbler unit either being attached to the housing or disposed in a separate housing in pneumatic communication with the floating housing through a pneumatic line.

### BRIEF DESCRIPTION OF THE DRAWINGS

FIG. 1 is a simplified schematic of the invention in block diagram and perspective form;

FIG. 2 is a drawing of a floating embodiment of the invention utilizing a separate bubbler unit; and

FIG. 3 is a perspective drawing of a further alternative embodiment of the invention wherein the bubbler unit is coupled to a floating housing.

### DETAILED DESCRIPTION OF THE INVENTION

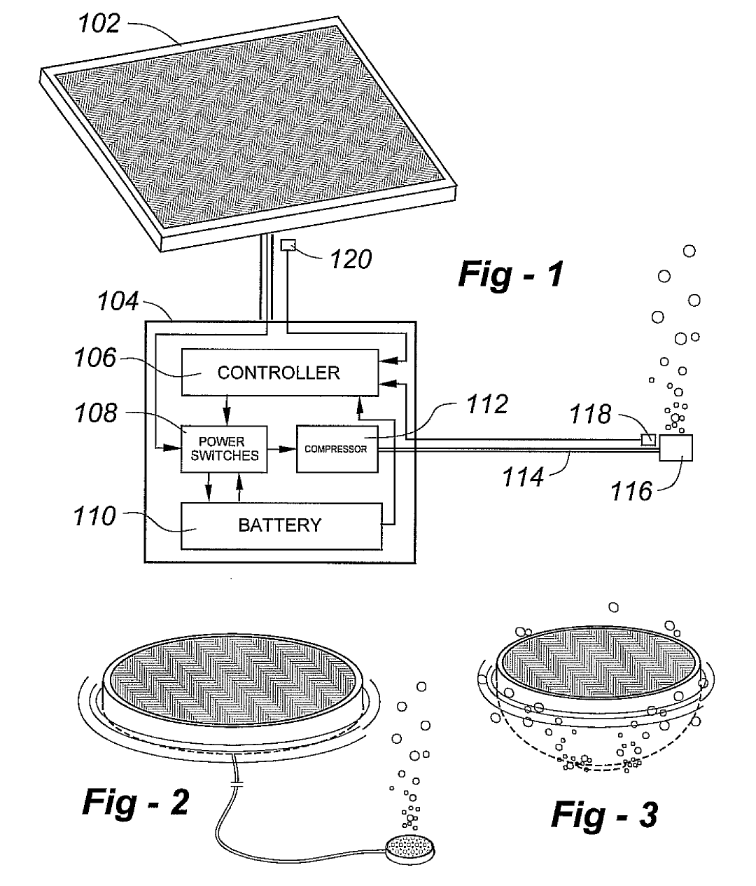

Turning now to the drawings, FIG. 1 is a simplified illustration showing portions of the invention in block-diagram form, and other portions in perspective. The system includes a solar panel 102 which may be of any known photovoltaic design, including single-crystal silicon, polycrystalline silicon, dual or twin cells, and so forth. The panel may be composed of multiple collectors, and each may be disposed on moveable platforms allowing the panel or panels to be manually or automatically oriented to the sun to maximize energy output.

Power from the panel 102 is directed into a housing 104 to a battery 110. While a direct connection to battery 110 may be possible according to the invention, in the preferred embodiment, power switches 108 are used for more regimented power transfer.

In the preferred embodiment, an electronic controller 106 is used to control the power switches 108, which, in turn, manage the charging of battery 110 and the power supply to compressor 112. Compressor 112 supplies air through pneumatic conduit 114 to bubbler 116, thereby preventing freezing in a desired water location.

While the invention contemplates a solar panel such as 102 charging a rechargeable battery pack 110 on a continuous basis, thereby powering compressor 112 to activate bubbler 116 so long as battery 110 is charged, in the preferred embodiment, elements are provided for a more efficient use of the system overall. For example, an electronic thermostat 120 may be provided to test ambient air temperature, with the controller being operative to activate compressor 112 only if a serious threat of freezing exists.

Additional electronic thermometers such as 118 may be provided under water, with controller 106 making intelligent decisions about water temperature versus ambient air temperature, thereby activating compressor 112 only as needed. Such decisions allow battery 110 to be charged to full potential, which may be an important consideration during wintertime. Those of skill in the art will appreciate that additional electronic thermometers may be provided, including thermometers at or near the surface of the water, to detect initial freezing conditions, and the like.

The system just described may be used in conjunction with water vessels of any size, including outdoor pet water bowls, livestock water troughs, and so forth. The invention is also applicable to larger bodies of water, including ponds, streams, and the like, in which case the system may be provided in a floating form. Referring to FIG. 2, such a form may include a solar panel exposed above water, with the housing being provided as a floating container, containing electronics of the type described with reference to FIG. 1.

In the embodiment of FIG. 2, a pneumatic tube may be coupled to the floating housing to a bubbler located at any distance from the housing, including on the bottom of a stream or pond, to prevent freezing at a particular location. As shown in FIG. 37 the bubbler unit may be attached to the floating housing, thereby resulting in an entirely self-contained solar collector and bubbler unit, as shown. The bubbles may emanate from the bottom of the floatable form, the periphery, or both. An anchor may be provided to keep the form in a desired location during deployment.

I claim:

1. A system for preventing outdoor ice build-up, comprising:
a solar panel outputting electrical power;
a rechargeable battery in electrical communication with the solar panel for storing the electrical power;
an electrically operated air compressor powered by the battery; and
a bubbler unit in pneumatic communication with the air compressor, the bubbler unit being submersed in water to be kept from freezing.

2. The system of claim 1, further including electrical switching apparatus to control the power supplied to the battery and the power supplied to the compressor from the battery; and
a controller operative to activate the switching apparatus on a per-demand basis.

3. The system of claim 2, further including at least one thermometer in electrical communication with the controller, the controller being operative to activate the bubbler if potential freezing is detected by the thermometer.

4. The system of claim 3, including a plurality of thermometers, one disposed in the water to be protected from freezing, and another being disposed outside of the water to test for ambient air temperature.

5. The system of claim 1, further including a pet or animal watering vessel containing the water to be kept from freezing.

6. The system of claim 1, wherein the solar panel and electronic components are disposed in a floating housing.

7. The system of claim 6, further including an anchor to keep the floating housing in a desired location.
